(19) United States
(12) Patent Application Publication
(10) Pub. No.: US 2012/0191417 A1
(43) Pub. Date: Jul. 26, 2012

(54) NOISE REDUCTION FOR SPECTROSCOPIC SIGNAL PROCESSING

(75) Inventors: Howard S. TAYLOR, Los Angeles, CA (US); Sharif KUNIKEEV, Kingston, RI (US)

(73) Assignee: UNIVERSITY OF SOUTHERN CALIFORNIA, Los Angeles, CA (US)

(21) Appl. No.: 13/245,713

(22) Filed: Sep. 26, 2011

Related U.S. Application Data
(60) Provisional application No. 61/403,974, filed on Sep. 24, 2010.

(51) Int. Cl. G06F 15/00

(52) U.S. Cl. 702/189

(57) ABSTRACT

A system with a data collection section and an algorithm is introduced that increases frequency sensitivity in 1D NMR Lorentzian spectra. Such spectra can be obtained for modest concentrations of solutes containing ¹⁵N and ¹³C (Carbonyls) and other low abundance nuclei in natural abundance. Lower levels of enrichment can be used if enrichment is at all necessary.

### CROSS-REFERENCE TO RELATED APPLICATIONS

This application is based upon and claims priority to U.S. provisional patent application 61/403,974, entitled “Noise Reduction for Spectroscopic Signal Processing,” filed Sep. 24, 2010, attorney docket number no. 028080-0609.

This application is related to U.S. Pat. No. 7,429,860 B2, entitled “Noise Reduction for Spectroscopic Signal Processing,” issued Sep. 30, 2008 (referred to herein as “the '860 patent”), attorney docket number 028080-0119, which claims the benefit of U.S. Provisional Application No. 60/445,671, filed Feb. 7, 2003, entitled “Processing Windowed Noise Reduction Signals for Fourier and High Resolution Signal Processing for Spectroscopies as NMR, ICR, etc.,” attorney docket no., 028080-0100, and U.S. Provisional Application No. 60/443,086, filed Jan. 28, 2003, entitled “Processing Windowed Noise Reduction Signals for Fourier and High Resolution Signal Processing for Spectroscopies as NMR, ICR, etc.,” attorney docket number 028080-0098.

The entire content of each of these applications and patent are incorporated herein by reference.

### BACKGROUND

1. Technical Field

This disclosure relates to nuclear magnetic resonance spectroscopy, including reduction of noise in free induction decay (FID) signals.

2. Description of Related Art

Nuclear magnetic resonance (“NMR”) spectroscopy is a basic tool that chemists use to learn about bonding of component atoms in molecules that they synthesize or find in nature.

Instruments measure spectra that can be interpreted to yield this knowledge. These instruments, however, can be very expensive ($700,000 to $3 million) and complex. During a measurement, a user may insert a sample into the instrument. After a given time ranging from minutes to days, the machine produces and sends a time signal to a computer called an FID (for free induction decay). This FID constitutes an average of many collected time signals called transients or scans, each of which has both a system originated signal and an often overwhelming noise component.

One primary challenge is to eliminate the noise from the FID as much as possible. Thereafter, the FID, which graphically may exhibit signal strength as a function of time, may be converted by a Fourier transform to a graph of signal intensely verses frequency. Peaked features in the spectrum yield frequencies needed to reveal molecular bonding.

A common approach to removing noise is to collect many transients in the FID, because noise decreases slowly as the inverse of the square of the number of transients. If the number of transients is sufficiently large, the spectrum, which ideally now has little noise would, for gases, liquids or solid samples (the latter collected by a technique called Magic Angle Spinning), may contain only Lorentzian signal features from whose shape the desired information can be extracted.

To minimize the time that must be spent on an expensive machine collecting transients, the number of transients may not be sufficiently large to adequately remove the noise. The characteristically grassy spectrum of noise then adds to the signal spectrum. This may give a total spectrum that may interfere with and hide the Lorentzians that are the object of the measurement. An example of this is illustrated in FIG. 3.2.

At this point, users may give up or undertake what often is a laborious, time consuming, and expensive procedure whereby chemicals, isotopically enriched in their magnetically active nuclei, are purchased and chemically incorporated into the sample to be measured. Such enrichment may cause the signal component of the FID to be larger, i.e., increases the signal to noise ratio (SNR), so that the standard art then works and the Lorentzian features are observable. In short the “sensitivity” is improved.

U.S. Pat. No. 7,429,860 discloses an approach to avoid enrichment or at least to reduce the degree of enrichment and/or to reduce the number of transients needed to obtain a spectrum having a good SNR. The result may also enable the frequencies to be determined to the required accuracy, while yielding a more useful spectrum.

There are nonlinear methods (Fourier is linear) of analyzing the signal, removing and producing good feature frequencies and better resolved spectra. The method used here is known as the Harmonic Inverse (HI) method. Many variants of the method exist and, if the noise is negligible, may give the same results. When noise is not negligible, this may not be true. The advantages are obtained when the equations for HI are used along with a well known mathematical method of their solution called singular valued decomposition (SVD). With these methods, the noise in the FID could be greatly reduced thereby reducing the number of needed transients, by a factor, dependent on the problem (for example 9, 25 or 30 etc.)

The HI methodology may have three problems. First, some user may want a black box method that inputted the FID and outputted results all measured in a relatively small numbers of hours and without any need to know any of the signal processing ideas, the associated mathematics and programming. The desired black box method may only require “clicking” a prompt on a computer screen. Second it may be difficult to determine the minimal number of transients for which the method worked. Third is the problem that, when using the HI+SVD methods, the number of final Lorentzian signal features (K) may have to be known prior to ever seeing the final spectrum. Overestimating K may give false Lorentzian features that unhappily resembled sample features. Underestimating K may lose some of the sample features; both unacceptable results. Solutions to the third problem may not be reliable at low SNRs. A first step toward a simultaneous solution to these three problems was documented in U.S. Pat. No. 7,429,860. There it was taught that the NMR machine could retain and output not only the final FID but all the data on transients contributing to the FID. The user could with help from the software then produce a ladder of FIDs holding increasing numbers of transients. When complete the user could extract the last three to seven of these and for each one order up an SVD curve (see Example 3, upper trace in the figures) from other supplied software. The series of such drawing ordered as in FIG. 3 that is downward with increasing number of transients, allows the user to see how and if the SVD curves (in FIG. 3 shows 32, 64, 128, 256 and 510 transients) topologically splits into two parts as the number of transients increase. In FIG. 3, as indicated by a circle for each singular value, it is seen that from the two lowest curves, that K will be one. From the totality of SVD curves it is seen that the left most singular value has stopped descending while the rest continue to descend. This creates a gap and the user recognizing this and now knows K=1. Creating a gap was a powerful way of determining K. Watching on the evolving SVD diagrams the change in shape of the SVD curves facilitates recognition of the gap when transients are limited. Once K is known, the user transfers this knowledge plus the FID to a program that preconditions the FID into to a new one which removes most of the noise and creates a low noise (cleaned) FID. The user then transfers this FID to the HI programs which produces, using the Matrix Pencil Method for HI, tables of computed parameters and a spectrum as in the lower trace in FIG. 3.2. The upper trace in 3.2 is the usual Fourier spectrum at the largest used in the HI method. The improvement is notable. If no brake or gap appears in lowest and final SVD curve, the method has failed.

Clearly when the gap did appear a spectrum is produced that at least for frequency is satisfactory while with the same FID the Fourier method is not. The word “satisfactory” means that to the required accuracy the frequencies agreed with those measure from enriched samples or from FIDs collected with many more transients.

Examples are given below.

### SUMMARY

An FID signal processing and graphing system may include a computer system configured to receive a set of FIDs, each FID comprising an average of a number of transients of measured NMR data from a single sample, the number of transients averaged in each FID growing across the set; produce a graph from each FID, each graph representing the singular values of the covariant correlation function of the FID; and cause all of the graphs to be displayed simultaneously in a manner that allows one or more higher singular values that are no longer decreasing in the graphs as the number of transients go up to be distinguished from lower singular values that are decreasing in the graphs as the number of transients go up.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1a-1g illustrate how a program allows a user to redo what was done for any initial rung for other rungs and to compare λᵢ diagrams as a function of Nₜᵣ.

FIG. 1.1 illustrates a Standard FFT of data after 3200 scans.

FIGS. 1.2a through 1.2 g illustrate scans and 8-fold expansions of the scans.

FIGS. 1.3.1a through 1.3.2g illustrate a FFT and HI comparison after 320 and 560 scans.

FIG. 1.4 illustrates a final HI of 560 scans with K=4 Denoised Spectra.

FIGS. 2a-2b illustrate a sample of 5% dicylopentadiene in CDL₃.

FIG. 2.2 illustrates a comparison of FT and HI on a Kavain sample, 240 transients, Line Broadening 1.11 Hz

FIGS. 2.1a1 through 2.1h2 illustrate a comparison of HI between 16 and 240 transients.

FIG. 3.1 illustrates a natural abundance of ¹⁵N NMR of 1.9M CH₃NO₂ in CDCl₃ with a line broadening of 0.99 Hz and a window of 256 points.

FIG. 3.2 illustrates Natural abundance ¹⁵N NMR of 1.9M CH₃NO₂ in CDCl₃ with a line broadening of 0.99 Hz.

FIG. 4.1 illustrates a Natural Abundance 15N NMR spectrum of [N5]+[SbF6]- in aHF (c=0.19M, 0.703 mM 15N) at −20° C. after 11,600 transients over 19.66 hours.

FIG. 4.2 illustrates a distribution of the singular values (beta nitrogen) after different number of transients for the −145 to −185 ppm window.

FIG. 4.3 illustrates how after 10800 scans; 6.15 sec/scan, 18.45 hours Concentration of 15N is 0.703 mM. Area 1.7:2:1 The α nitrogen's low area is due to a relaxation effect.

FIG. 5.1 illustrates a two isotopomers of the N5+ sample.

FIG. 5.2 illustrates an Nβ region in the ¹⁵N NMR of 1.6 M N₅SbF₆-1-¹⁵N in DF with a line broadening of 8 Hz and a window of 275 points. Upper trace: SVD curves; lower trace: corresponding HI spectra with K=5.

FIG. 5.3 illustrates an HI spectrum of the N½ region in the ¹⁵N NMR of 1.6 M N₅SbF6-1-15N in DF with a line broadening of 8 Hz and K=3 after 40,000 transients.

FIG. 5.4 illustrates an N_{β} region in the ¹⁵N NMR of 1.6 M N₅SbF₆-1-¹⁵N in DF with a line broadening of 8 Hz after 40,000 transients. Upper part: traditional FT spectrum; middle part: SVD diagram; lower part: HI spectrum with K=3.

FIG. 5.5 illustrates an N_{β} region in the ¹⁵N NMR of 1.6 M N₅SbF₆-1-¹⁵N in DF with a line broadening of 8 Hz after 20,000 transients. Upper part: traditional FT spectrum; middle part: SVD diagram; lower part: HI spectrum with K=3.

FIG. 5.1a illustrates an ³¹P NMR spectra of I, 67 mM in methanol-d4/methanol (1/4). (a) FFT, after 0.5 h, (b) FFT, after 2 h, (c) DSNMR, after 0.5 h, (b) DSNMR, after 2 h.

FIG. 5.2a illustrate a ³¹P NMR spectra of I, 8.4 mM in methanol-d4/methanol (1/4) Nₜᵣ=40,000 (20 h). (a) FFT without damping.

FIG. 5.3a illustrates ³¹P NMR spectra of I, 0.058 mM in methanol-d4/methanol (1/4) Nₜᵣ=40,000 (20 h). DSNMR-derived spectrum (upper), FFT spectrum (lower).

FIG. 6.1 illustrates a ¹⁷O NMR spectrum of H₂O (natural abundance, 0.037%) in pyridine, concentration 170 mM (63 μM of ¹⁷O) at 92° C. after 8000 scans. DSNMR spectrum (upper), FT spectrum (lower). The chemical shift of the observed DSNMR peak was arbitrarily set to 0.0 ppm.

FIG. 6.2 shows a comparison of FFT (lower, broken trace) and DSNMR (upper, solid trace) of ¹⁷O NMR spectra (left) and the singular value plots (right) of H₂O in pyridine, concentration 68 mM (25 μM of ¹⁷O) at 92° C. Nₜᵣ=58,000 (18.3 h).

FIG. 7.1 illustrates a SVD curves for five steps of the 15N acquisition.

FIG. 7.2 illustrates a harmonic inversion spectra from the SVD curve above. K=3

FIG. 7.3 illustrates an Upper Trace: Standard FT after 8 scans, LB=9.8 Hz. Middle Trace: Standard FT after 72 scans and Lower Trace: HI spectrum after 72 scans.

FIG. 8.1 illustrates ¹⁵N enriched Zr-MOF—NH₂.

FIG. 8.2 illustrates an SVD curves for last four steps of the 15N acquisition.

FIG. 8.3 illustrates a harmonic inversion spectra from the SVD curve above. K=3

### DETAILED DESCRIPTION OF ILLUSTRATIVE EMBODIMENTS

### Introduction

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Random noise arising from the measurement process and equipment is the reason that large numbers of transients are needed in NMR measurements. See Ernst R. R., Bodenhausen G., Wakaum A.: Principles of Nuclear Magnetic Resonance in One and Two Dimensions (Oxford University Press, London 1987). To observe the signal features in the Fourier time to frequency method (FT) sufficient transients (Nₜᵣ) must be collected to raise the signal to noise ratio (SNR) to say about three to five. The algorithm, meaning the totality of all steps and operations discussed below, here assumes a model in which the isolated signal lines are Lorentzian. This is rigorously valid for gas and liquid phase samples and for solid samples accumulated with MAS. It is empirically found that acceptable spectral frequencies can be achieved when the number of transients collected arrives at a SNR ratio of about 1.10. This has been obtained for challenging problems involving ¹⁵N, ¹⁷O, ¹³C (quaternary) and very low concentrations of other nuclei. The algorithm which involves no chemical modification often makes enrichment unnecessary. See Y. Y. Lin, P. Hodgkin, M Ernst, A. Pines, J. Magn-Reson., 128, 3041 (1998); Jean-Baptisfe Poullet, Dana M Sima and Sabine Van Huffel, J. Magn-Reson. 195, 134-144 (2008); P. Koehl, Prog. Nuc. Magn. Reson Spectroscopy, 34, 257, (1999); when this is not possible it can lower the amount of enrichment needed. The present method requires, for reasons of internal statistical assumptions, at least 10 transients.

The algorithm has two additional smaller features which could be of use for all systems to which it can be applied. First is that the resolution is enhanced relative to the FT method by a factor of D_{average}/Dₘᵢₙᵢₘᵤₘ, D being an adjacent interline distance; this is why the Harmonic Inversion (HI) time to frequency processor is called a “high resolution processor”. Second is the fact that the method works in this version of the algorithm in windows of usually 100 to 500 Fourier grid points in width so as to limit the number of spectral features and to allow the internal computations to take little time. It makes the analysis which is interactive able to be accomplished in one relatively short sitting. Often as shown in our Examples this is not a serious restriction. Numerical problems in the internal computations and computation time inconveniences might occur if this was not done. To obtain a full spectrum, half overlapping windows need to be patched together as inaccuracies occur at the window edges. For spectra over the total bandwidth, the number of transients needed will be determined by the window with the weakest feature. So, if you know where the weakest features will be, work there first. The reason for this will become clearer below.

The HI method tabulates the four parameters, the frequency, the area, the phase and the width of each resonance, draws the Lorentzian curves and adds them together to produce a spectrum using Eq. 8 of Reference 2. The assumption in the theory underlying the algorithm that an isolated spectral signal feature can be represented by a Lorentzian, agrees with NMR theory for the gas, liquid phase spectra and for solid phase spectra collected using MAS. It is this assumption that is the “extra information” that gives the algorithm its advantages and limitations relative to he FT method.

From simulations and experience with the HI it has been observed that obtaining good frequencies requires the least number of transients. Areas and phases would require many more transients to obtain accurate results and decay rates seems poor.

### Underlying Theory

The important facet of the method presented below and in reference 2 is its use of an algorithmic process that is aimed at increasing sensitivity in a systematic way so as to reduce the number of transients needed to obtain a spectrum. Some words about how the method achieves it's aims are in order. In the FT method the experimentally observed FID is represented in a basis supplied by the discretization of the time representation of the function exp(iωt). When this representation is Fourier transformed, the result is a stick spectrum which at the Fourier grid points represents the weight or intensity of the spectrum at each grid point. Ignoring the noise and resolution problem, this result can be used to represent almost any functional form of the FID and of the final spectrum. For a given number of transients (Nₜᵣ), the transient averaged FID represents signal and noise contributions to the spectrum equally well. In particular each “stick” can have both signal and noise contributions with no obvious way to separate them. The only generic procedure to reduce noise and to obtain the signal contribution is to collect more transients, that is to increase Nₜᵣ so that the noise decreases proportional to \sqrt{Nₜᵣ}. In the new method, the signal accumulation differs only slightly from the usual in that a small program called ‘Multisave’ is easily added to the NMR instrument once and only once. The instrument then saves the signal averaged FIDs at incrementing values of Nₜᵣ in what we call ‘memory steps’. The change in Nₜᵣ between steps, A, as is the total accumulation time, is set by the user based on experience with the method. Hence a ladder of FID's with increasing Nₜᵣ, having steps with Δ transients, 2Δ transients etc, is accumulated. The analysis is usually done after the accumulation but it can be done as each step is completed and saved. The user starts the analysis by first choosing the highest step in the above constructed ladder to be analyzed as this will make it easier to ‘see’ and window tentative features of interest in the FFT spectrum. Then the end points of a 100 to 500 Fourier grid point window are chosen after, if possible, phasing of the spectrum using any observed features (even the solvent). It is assumed here that the maximum number of transients does not give a satisfactory FFT and that many more transients will be needed to do so. At this point the software proceeds to the analysis of the internally produced windowed signal. The HI will use the matrix pencil equations obtained from the “Lorenztian” spectral model to compute the frequency and decay rate. See S. Kunikeev and H. S. Taylor, J. Phys. Chem. A 108, 743-753 (2004); J. A. Cadzow, IEEE Trans. Acoustics, Speech, Signal Processing 36, 49-62, 1988; V. Mandelstam and H. S. Taylor, J. Chem. Phys. 108, 9970-9977 (1998). The model expresses the known measured time samples Cₙ(t=nτ, τ the time delay) containing both signal and noise in terms of a sum of weighted damped harmonic functions parametized by the well known Lorentzian parameters (The Fourier transform of a Lorentzian is a damped harmonic) and numerically inverts the model to give the parameters as a function of the Cₙ. Following the procedures discussed below, when Nₜᵣ is high enough, the spectral Lorentzian features are either mostly signal or mostly noise. No “grassy” noise is seen. It is replaced by noise packaged as Lorentzians and as error in the predicted parameters. The whole algorithm can be viewed as a way to recognize and then discard the noise Lorentzians. There are two ways to do this. First, before using the HI method, the SVD program will use the windowed transient averaged FIDs to produce foe each a singular value list in the form of the SVD diagram or curve that with a sufficient number of transients separates, as Nₜᵣ increases, into a signal part and a noise part that is it develops a ‘gap’. The former leads to a “cleaned” or “noise reduced” windowed FID, and the latter part is discarded once the separation is recognized. The HI method then takes each cleaned FID (the word windowed is now implicit) and produces a spectrum made up of separate or perhaps overlapping Lorentzian functions, each indexed by it's parameters. The catch is that the SVD methods for success in “cleaning” the FID depends on a decision made by the operator viewing the SVD graphs. Each graph shows a plot of a set of usually about 40 positive real numbers λᵢ, (which actually are the square of the usual singular values of the data matrix but for this document we call them the singular values) and whose value on the ordinate goes down as their index goes up on the abscissa. A log plot is also available and can be useful in observing the spacing between adjacent λᵢ values. The top figure in example 3 is a good example of such plots for different number of transients.

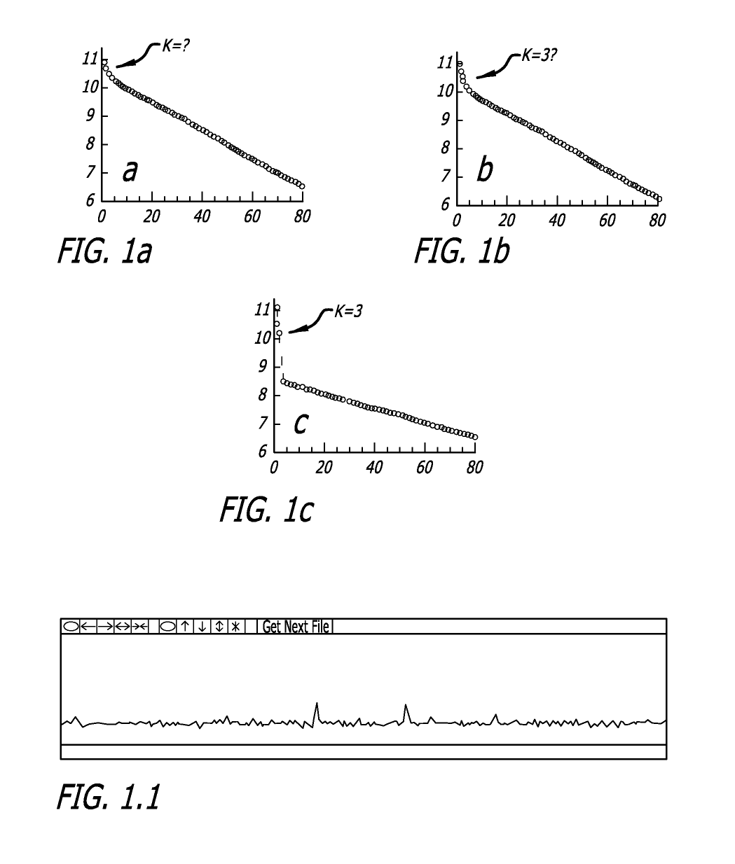

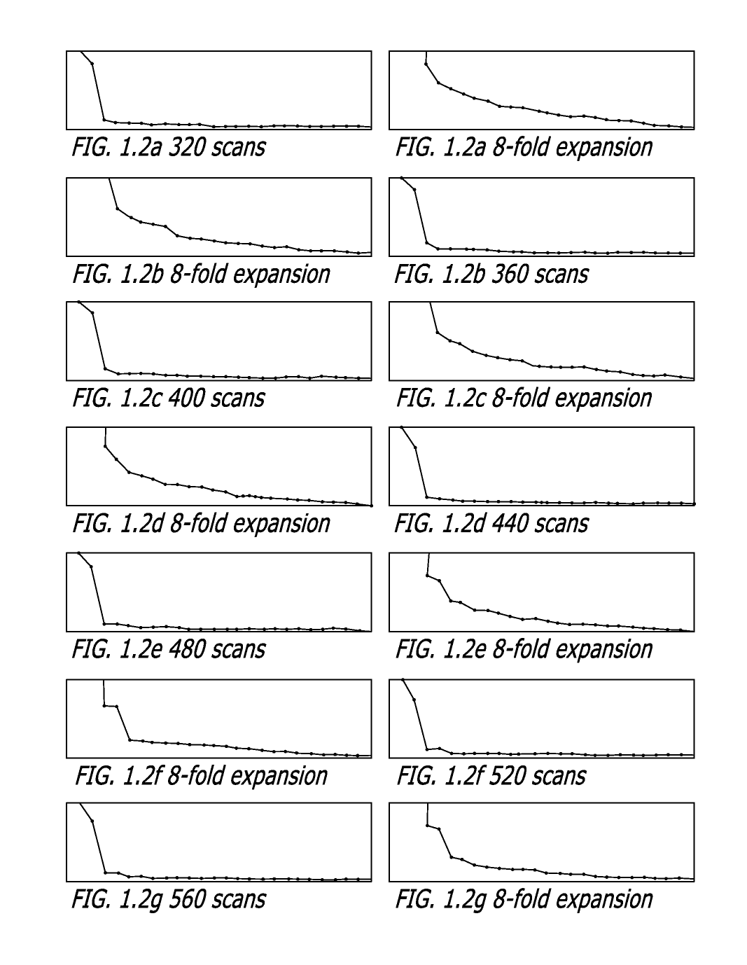

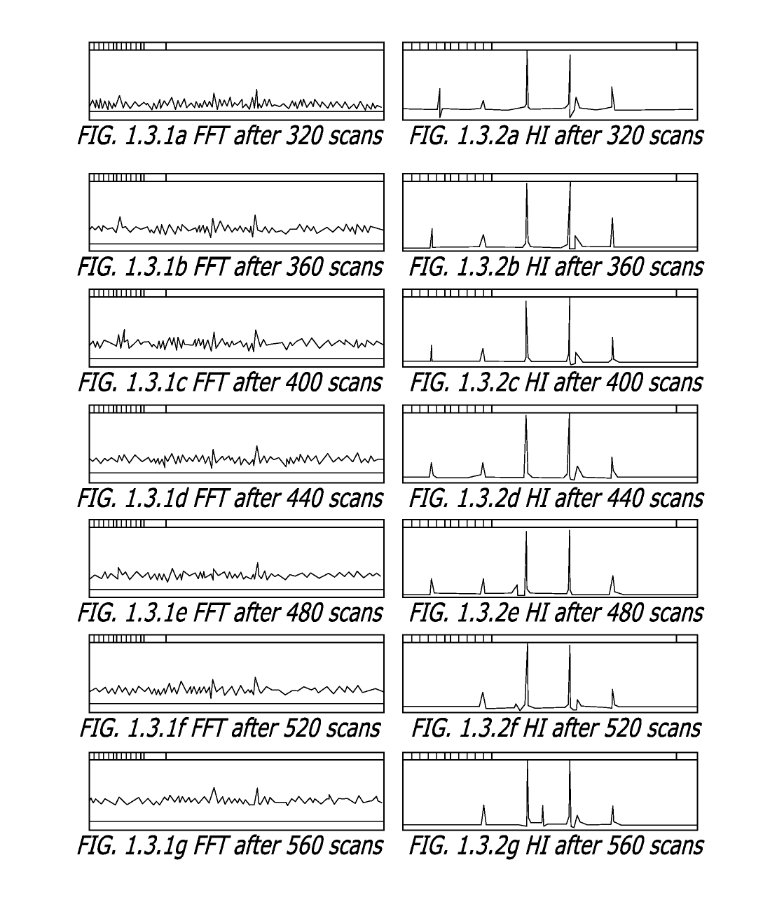

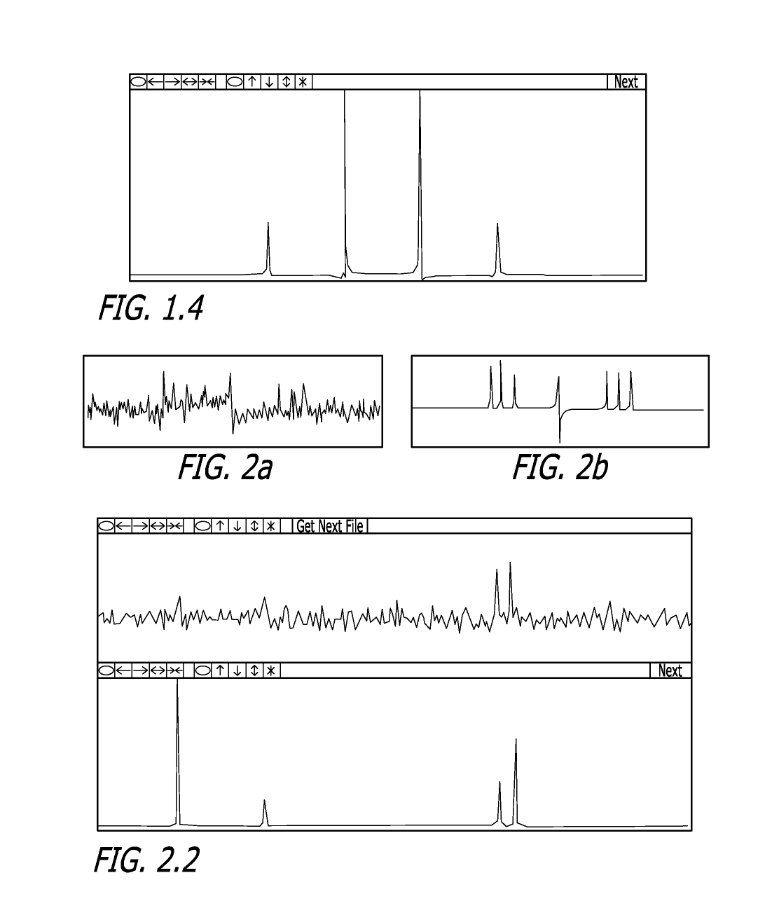

A singular value can if the method is successful, be associated with a mainly signal or a mainly noise feature in the eventually obtained spectrum. For a FID made only of noise, each λᵢ (from theory) has a value equal to the variance (σ²) of the noise. The λᵢ graph would then exhibit singular values that appear as a horizontal “string of pearls.” Ideally the string will actually be parallel to the abscissa, but for reasons of windowing and noise it sometimes slopes downward. As Nₜᵣ increases, the line's distance from the abscissa decreases as Nₜᵣ⁻¹. On the other hand, if there had been signal information in the noisy FID and if this would have eventually lead to say K Lorentzian spectral features, then as Nₜᵣ increased and the noise decreased, the first K singular values would decrease more slowly in value in a process that ideally “wrings” the noise out of them (there is always some noise left) leaving only the signal component. The latter λᵢ's would no longer decrease with additional transients. They roughly stabilize in value, largest feature first, on their respective vertical index lines. Empirically when a λᵢ detaches and eventually leads to a spectral feature at say frequency ω it occurs at a SNR which in the Fourier Spectrum is found to be “locally about ω” of at roughly 1.1, a value at which the Fourier spectrum cannot differentiate between signal and noise. The 1.1 was noticed after the new method first gave the frequency of the line at some Nₜᵣ. Then, when going back to the Fourier spectrum at this Nₜᵣ, we would observe that one of the “grassy” lines, in what was previously thought to be all noise, had just emerged from the surrounding “grass”. Clearly, this is not a good way to find K. What is more attractive is to watch the above described evolution of the λᵢ diagrams as one climbs (up or down as the user chooses, the software facilitates this process) the FID ladder. The program allows the user to redo what was done for any initial rung for other rungs and to compare λᵢ diagrams as a function of Nₜᵣ (see FIG. 1.2a-g) in search of a gap.

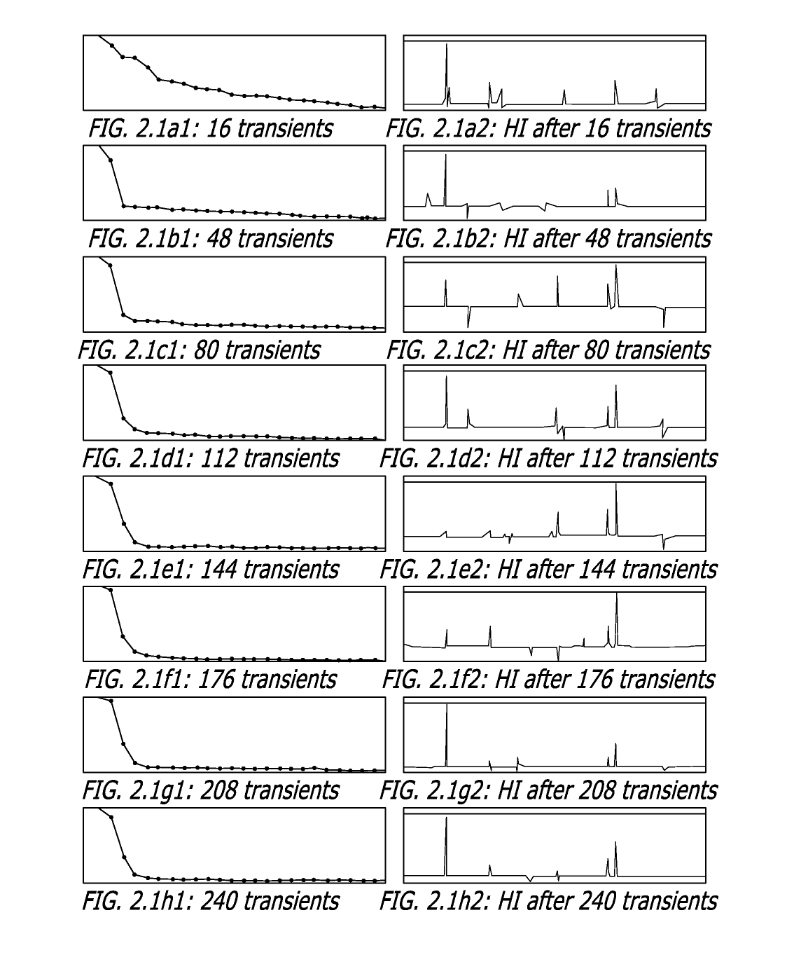

Hence as Nₜᵣ increases, the stabilization of K singular values resembles a situation where one, two, or several of the left most “pearls” no longer appear to continuously decrease in value as rapidly as the remaining “string of pearls”. This causes the λᵢ to lie on a curve that, for example, resembles that shown in FIGS. 1a to 1b; the latter derives from an FID with more transients than 1a. If K was not known, sufficient transients would be needed to get to a graph as in FIG. 1c where the distance between the last stabilized λᵢ and the left most λᵢ the string of pearls is well defined; which in practice means that the leftmost pearl on the string is and will always be heading down as the ladder is climbed. This distance is the “gap” and its existence determines K in the usual situation where it is not known. At an Nₜᵣ corresponding to FIG. 1b, it is not clear if the 4^{th} singular value will detach and stabilize. K cannot be specified; it could be 3; it could be 4. This region of the curve, where this uncertainty exists, always has the shape of an “elbow” (Note: in analogy to a cocked arm with the downward heading string of pearls called the “forearm”) and is referred to as such. As seen in FIG. 1c, the λ₄ decides to join with the string of pearls determining in our example K as 3. The general rule is to say that when the elbow is observed and a correct estimate of K is made, that with more transients the gap should grow as the pearls with their index greater than K, appear to be progressing downward. FIG. 1c is the ideal situation; the gap is big. A big gap is the “Gold Standard” for this method. Enough transients should, when possible, be taken to definitively show the gap and define K. Examples 4, 5, 6, and 7 were done this way as were the ¹³C examples shown in reference 2 among which was the 1D INADEQUATE spectrum shown in FIGS. 2a and 2b.

The question now arises as to what happens when the experiment must be stopped when the top step has an SVD diagram resembling FIG. 1b? The gap might be set with K at 3 or 4 or perhaps even more. Can the number of signals features be determined earlier in the evolution of the SVD graph? Related is the observation that just as in Fourier processing, there is always the possibility that as Nₜᵣ increases a relatively quite small peak (albeit of the same scale) still appears in the spectrum which might mean that another pearl is stabilizing. What should one do? Increase K? The problem is that such increased and possibly too large values of K could also give false Lorentzian shaped noise features in the spectrum. The “more transients” to go to FIG. 1c answer is a good one; but what if they cannot be obtained? Clearly any help in specifying K would be welcome. A “helping” technique is available and is also our second method to remove noise. To appreciate it requires we first explain how the spectrum is obtained. Note all but the choice of K is done automatically in the software.

At each given Nₜᵣ step, the SVD program takes the available windowed transient averaged FID and creates data vectors as follows. As decided by computer memory size, the program might take the hundred Cₙ starting with C₁ as the first vector; the hundred starting with C₂ would be taken as the second vector and so on. These vectors then become the columns of a so called Hankel data matrix which when multiplied from the right by its conjugate transpose gives by construction a Hermitian covariant correlation matrix (R) whose real eigenvalues are the square of the singular values and must be positive. The eigenvalues, which are our plotted “singular values”, and eigenvectors of this matrix are then obtained by diagonalization of R. The data vectors are then expanded on these eigenvectors. The eigenvalues make up the SVD diagram and after your choice of K, the program then sets in the expansion of the data vectors on the bases of the eigenvectors the weights of the eigenvectors K+1, K+2, etc to zero, thereby eliminating most noise by eliminating all components of the data vector that have been seen to be associated with noise. What remains is a “cleaned” expansion of the data vectors, whose components are the cleaned Cₙ^{cleaned}. These are used to construct cleaned FID elements and, equivalently, a cleaned FID. The process is then iterated 3 to 5 times (default is 3). See J. A. Cadzow, IEEE Trans. Acoustics, Speech, Signal Processing 36, 49-62, 1988. The resulting cleaned signal is then fed into the HI program which “fits” the data to K Lorentzian functions by solving for their individual parameters. The Lorentzians are then drawn along a frequency axis and summedat each frequency to give the spectrum.

As said before, a method for supporting in the choice of K at an early stage of a possible separation of the SVD curve would be helpful. An error in choosing K comes at a high price. Too small a K value omits signal features; too large adds false Lorentzians to the spectrum. These latter Lorentzians are packages of noise that replace the grass noise seen in the Fourier Spectra. Eliminating them by a proper choice of K eliminates most noise. The little that is left, is in the “error” in the parameters of the Lorentzian and this, albeit small, can be eliminated only by further transient collection. Some earlier attempts to use non-linear methods were distrusted as they sometimes gave false peaks, they overestimated K or didn't bother to estimate it. The second noise reduction method used here actually takes the “bull by the horns” and intentionally overestimates K. It depends on the fact that the noise is random and that it is not represented well by the Lorentzian functions forced on the noise by the Harmonic Inversion method. Changing Nₜᵣ then causes the noise structures in the spectrum to change their frequency. Their associated Lorentzian features seem to move about or change shape; their areas should decrease with an increase in Nₜᵣ. Moreover, it has been observed that such noise lines phase individually. True signal lines phase coherently and are quite stable although they may change to a much smaller degree with Nₜᵣ. Hence our prescription is, after the window is chosen, to allow the user to choose any step or sequence of steps (up or down the ladder). For each chosen step, (assume we are going up the ladder) an SVD curve is calculated and shown. If the SVD curve is not even provisionally satisfactory, one can go up some more steps and repeat the procedure until the SVD curve at least suggests the value of K by exhibiting an elbow. Then deliberately overestimate K, i.e. choose K in the “forearm”. Clicking on the K^{th} pearl in the singular value diagram automatically gives rise to a displayed cleaned Fourier and a cleaned HI spectrum which can then be phased. In the HI Spectrum it is possible that some Lorentzians might overlap, so an “x” marks each Lorentzian in accordance with the tables. Now, higher steps are chosen (the lowest was the first) and the procedure is repeated.

The user will be able to specify how many steps of SVD and associated HI spectra he wants to work with. At this point, the graphics will allow vertical comparisons of these curves and spectra. One can then see in the SVD curve that the gap estimation is becoming easier as the motion of each λᵢ can be observed.

The sequence of HI spectra show which peaks are stable with respect to frequency. Signal Peaks that phase coherently phase individually allowing distinction. Noise peaks generally phase in ways unrelated to signal. Remembering that the ladder of data is always available at full signal length, if further uncertainty exists the instability of noise may be revealed by redoing the analysis at signal lengths of N/4 and N/8, etc. Default at N/3. Window size and centering can be varied. Of course the “phasing as a filter” will not help in spectral windows with only one signal feature. Conversely if no two features phase together then for this Nₜᵣ, it can be said that the number of signal features is zero or one. Frequency stabilization could then be the only way to distinguish signal from noise features.

Success in this process will give high confidence in the choice of K and should do away with the need or inability to obtain very large gaps. The program will instruct the user how to graphically make such comparisons in a vertical, line by line, manner. The spectrum is made by either discarding the noise features or by repeating the procedure with the choice of K as given by the now known number of signal lines. This first method is safer, the second, prettier. If there are any differences, the first method is the more correct one as it is always possible that a noise Lorentzian has more area than the K^{th} signal peak, causing the noise feature to be retained while simultaneously rejecting the smaller signal feature as noise. (Recall that larger features correspond to higher valued λᵢ). Of course, all spectra are available in tables that give the parameters which could also be used for comparison. Line widths should not be used to study stability as they are less precise than frequencies. If any doubt still exists, get more transients. If none of this is possible, admit defeat but with the consoling knowledge that what you have done has brought you closer to the true answer than the Fourier method would have.

Even when the spectrum looks as one might expect it is wise to estimate the minimum variance, equal to the maximum precision using the Cramer-Rao bound. See S. M Kay, “Modern Spectral Estimation”, Prentis-Hall, Englewood Cliffs N.J. (1987); H. Barkhausen, R. de Beer amd D. Van Ormondt, J. Mag. Reson., 73, 553 (1992). Poor precision makes the parameter suspect. Monte Carlo calculations. See A. Diop, A. Briquet, and D. Graveron-DeMilly, Magn. Reson. in Medicine, 27, 318-328 (1992); R. Stoica, Hongbin Li and Jian Lee, IEEE Trans. Signal. Process. 48,338 (2000); Y. Y. Lin, P. Hodgkin, M Ernst, A. Pines, J. Magn-Reson., 128, 3041 (1998). indicate that the method gives acceptable frequencies. Decay notes are especially poor. Areas and phases must be used with caution, always asking “does the precision” allow reliable ratios of areas to be estimated? If areas are essential and machine time is not a problem generating say 25 times the number of transients finally needed in the above procedure allows it to be repeated 25 times using 25 independent sets of transients. The average value of the parameters might then be much more reliable. See A. Diop, A. Briquet, and D. Graveron-DeMilly, Magn. Reson. in Medicine, 27, 318-328 (1992). Of course with this number of transients the present method might not be needed unless integration under Fourier features is difficult.

### Special Considerations

Using larger damping than the default may be useful or even necessary to observe gaps and/or to observe feature stability. Damping has the same advantages and disadvantages as in the Fourier method although HI has a generic higher resolution; noise can be cut but perhaps at the price of not observing small features and splittings. For problems that do not give clear results, studies of the effect of increasing damping should be made and often were made in the given examples.

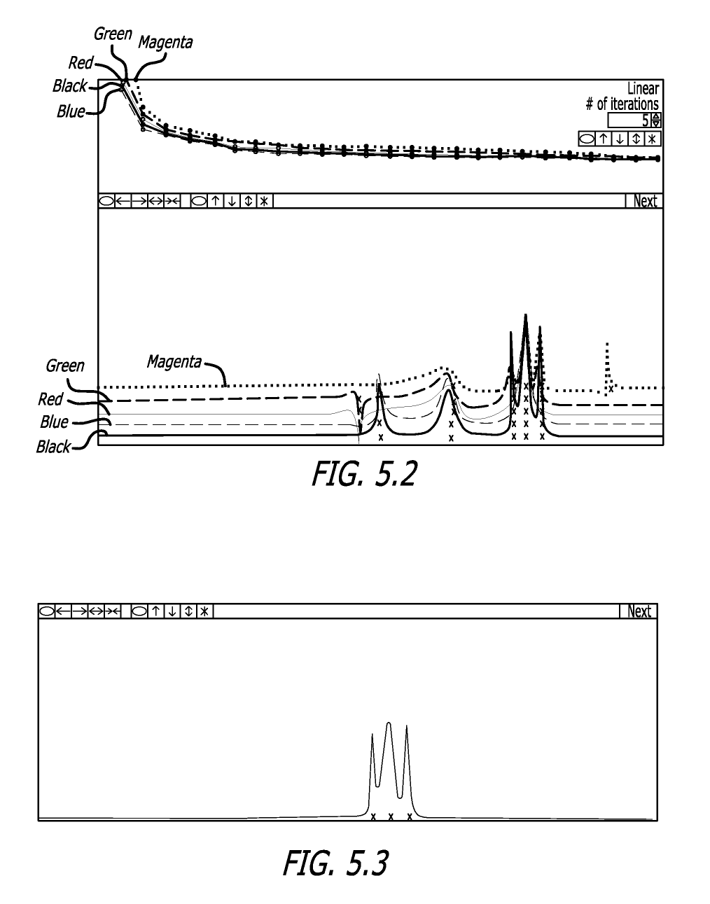

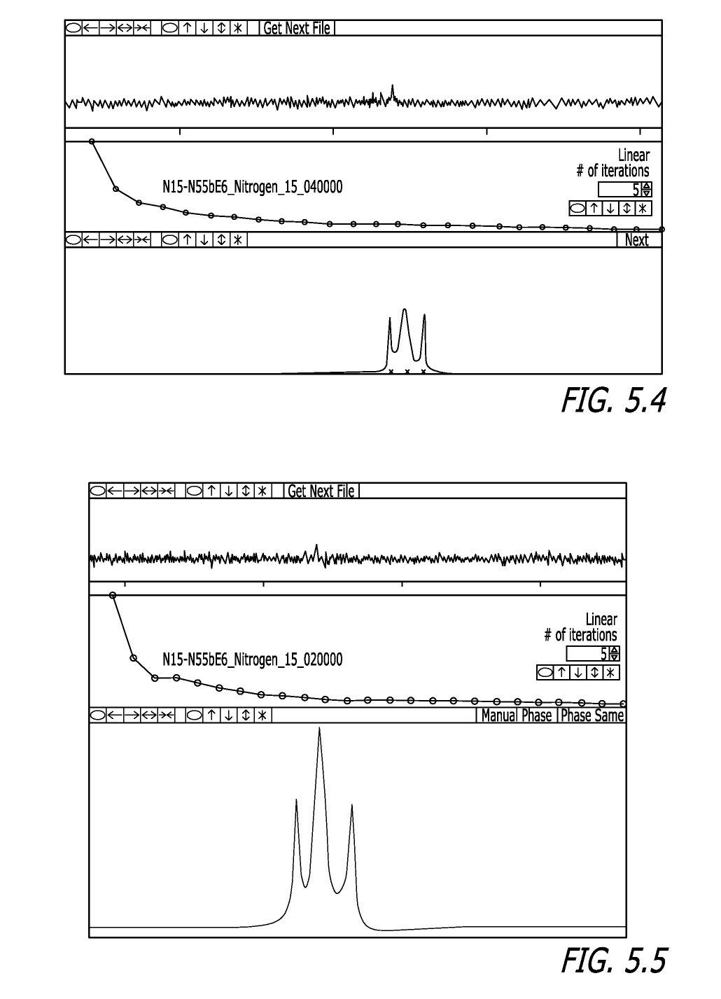

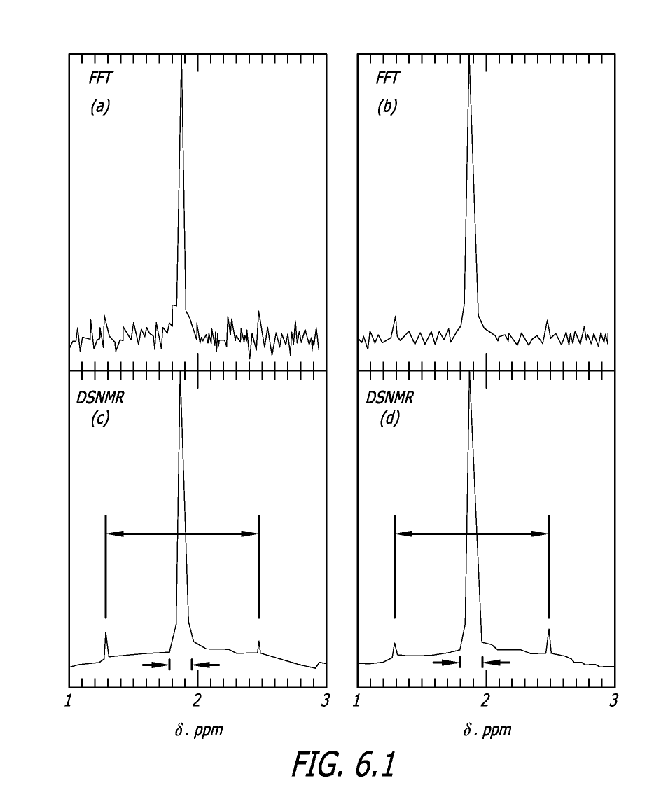

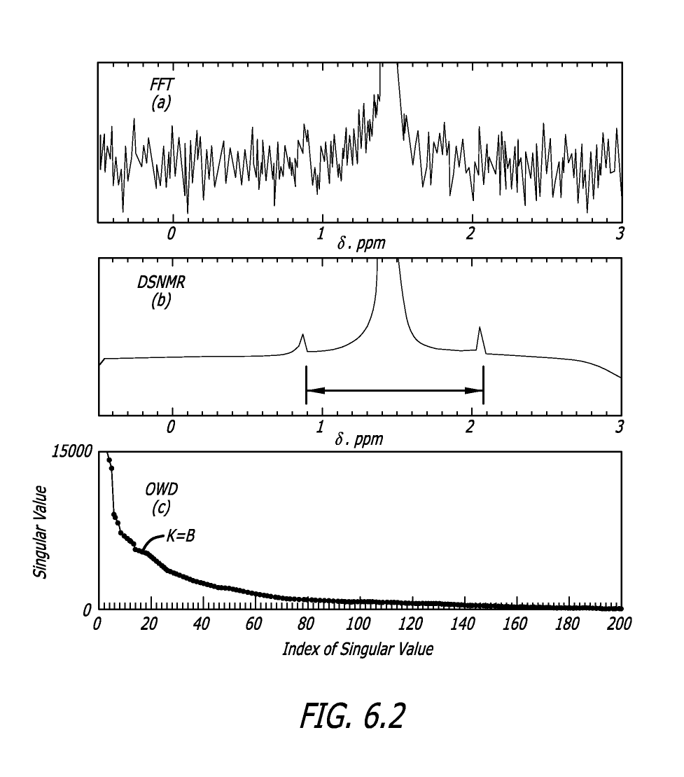

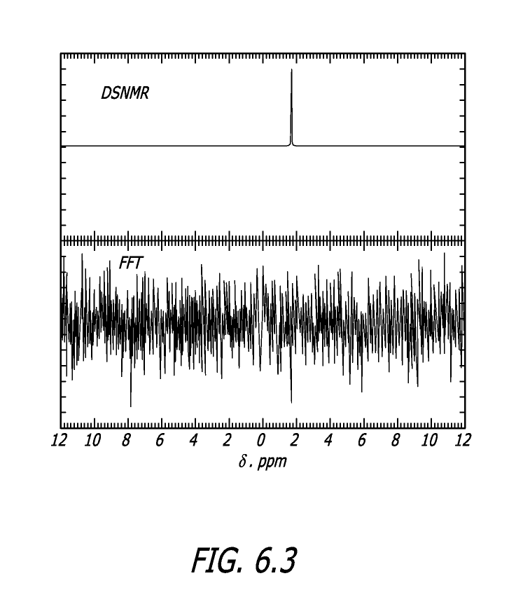

The case where spectral features, which may be what is being looked for, appear on a background or on the “foot” of a very large feature which could even be a solvent line needs special discussion. The gap may be harder to pin down here, but the elbow may not be, so that, as in the case where no clear gap is observed, overestimation of K followed by the use of procedures to distinguish the signal peaks may be the only option. That this can be done is seen in FIG. 5.2. In cases with background the model is trying to fit to Lorentzians, signal peaks and noise peaks as before, but now also an often wavy or sloped background. In such cases, several more singular values, namely those needed to fit the background may appear in the “upper region” of the SVD diagram. These singular values can be large so as the fit to the “base” which may need very broad, large area Lorentzians. This would mean that the first singular values seen might be associated with the baseline. As such, as was done in Examples 5 and 8, overestimate the gap; remove noise by phasing and stability; signal features should have stable “x's”; x's associated with any base lines can move a bit but are recognized by their large width and because they will not have their own “peaked” Lorentzian. Background removal methods could perhaps be incorporated into the algorithm. See Jean-Baptiste Poullet, Dana M Sima and Sabine Van Huffel, J. Magn-Reson. 195, 134-144 (2008).

In the case where there are some very big lines and some very small lines, for example a dynamic range problem, the first gap is not where one stops; a second gap must be sought by obtaining more transients. In short, do the problem as two successive problems.

The method can in principle treat the case of a dense forest of lines in the window. It did so for quantum chemistry problems where no noise exists. The problem here would be with the recognition by phasing and stability of the noise lines. A noise line might be hard to spot and it might overlap signal lines. The method might fail unless one satisfies, with margin for error, our “golden rule”; accumulate until a gap appears.

The more foreknowledge brought to the problem the easier it is for the algorithm to contribute useful knowledge. For example, if we are looking for a quartet and K is overestimated in an Nₜᵣ case showing no gap, the appearance of four equal spaced lines gives the splitting even if other lines, noise or signal, remain unidentified.

Clearly the method is not a pure black box. User judgment is required. The Fourier method is a black box at the price that the experiment might not be able to be finished.

To get an estimate of the variance of the noise rather than try to read it off the SVD diagram it is not difficult to calculate it. Since Cₙ^{windowed} is made of both signal and noise, Cₙ═Sₙ+ηₙ and the cleaned signal is hopefully a good approximation to Sₙ, it is sensible to compute σ² as

$${σ}^{2} = \frac{1}{{M}_{window}} {\sum }_{n = 1}^{M} \vert {( {C}_{n}^{w} - {C}_{n}^{wcleaned} )}^{2} \vert \approx \vert {η}_{n}^{2} \vert$$

M is the number of windowed grid points; w indicates windowed. The formula has not been extensively tested and the existence of window edges near which we know trouble exists might make σ² larger than it should be.

If the FID is shifted to start with C_{ñ}, the spectrum and table must be reconstructed feature by feature. This is easily done by multiplying the tabulated complex dₖ (here the complex weight of each harmonic in the model and determined by the area and phase), by exp[iωₖñτ] and replacing the original dₖ^{Real} and dₖ^{Imaginary} in the table by the real and imaginary, respectively, values of the product. The spectrum can then be reconstructed using Eq. 8 in S. Kunifeev, H. S. Taylor, J. Phys. Chem. A 108, 743-753 (2004).

A note on the figures. To the experienced NMR user, the noiseless, i.e. “grassless”, flat baselines appear too good to be true. In fact they are. Our noise error is either in the Lorentzian noise features which we can get rid of or ignore (after testing) and to a much lesser extent in the error in our parameters (in the tables).

There are many harmonic inversion schemes which, to the accuracies required, for the noiseless case all give the case the same results. They go under names such as Filter Diagonalization (See V. Mandelshtam and H. S. Taylor, J. Chem. Phys. 107, 6756 (1997); See section 2A), Matrix Pencil (V. Mandelshtam and H. S. Taylor, J. Chem. Phys. 107, 6756 (1997); See section 2A; R. Roy, A. Paulraj and T Kailath, IEEE Trans. Acoust. Speach Signal Process ASSP-38, 814 (1990); Y. Hua and T. K. Sarker, IEEE Trans. Signal Process, 39, 892 (1991)), total least squares, Linear Predictor (See Press, W. H., Flannery, B. P., Teukolsky, S. A. Vetterling, W. T. Numerical Recipes in C. Cambridge: Cambridge University Press, 1988), Pade Approximation, Decimated Signal Diagonalization, etc and there is a vast literature in signal processing associated with them. See Jean-Baptisfe Poullet, Dana M Sima and Sabine Van Huffel, J. Magn-Reson. 195, 134-144 (2008). The Cadzow signal processing method of SVD analysis (See J. A. Cadzow, IEEE Trans. Acoustics, Speech, Signal Processing 36, 49-62, 1988) that we use arose from the field of acoustics. It is one of many SVD schemes. Cadzow seems simpler and suffices for our use. Due to the model used here, where the SVD process separates signal from noise as briefly explained above, SVD actually does much more. There is a hidden problem here is that the unknown complex signal parameters are 2K in number and therefore less in number than the number of data samples in the FID (K<<N). Hence we have to solve linear equations that arise in the method that are over-determined and therefore ill-conditioned. In order to solve the Matrix pencil equation for HI, the data matrix needs to be inverted and it has a rank (K) that is smaller than its dimension (usually taken to be about one hundred but call it here M). As such it is singular and cannot be inverted, that is the determinant of the data matrix is zero. SVD tells us how to construct a pseudoinverse that can do the job. In doing so, it notes that the SVD solution to the equations involves an M×M diagonal matrix which when inverted has M−K diagonal values for k>K which become large and go to infinity as noise is eliminated. This would cause unacceptable numerical instability on any finite register computer when solving linear equations by LU and Gaussian pivot methods. SVD avoids this problem by setting the infinite numbers to zero. (Where else can you do this? See Press, W. H., Flannery, B. P., Teukolsky, S. A. Vetterling, W. T. Numerical Recipes in C. Cambridge: Cambridge University Press, 1988). It gets answers with a proper choice of K that makes the solution for what will be the Harmonic Inversion solution acceptable in the minimum residual sense. Note we now have two reasons for ignoring the k>K singular values. The literature on the SVD method is more vast. “Numerical Recipes” (See Press, W. H., Flannery, B. P., Teukolsky, S. A. Vetterling, W. T. Numerical Recipes in C. Cambridge: Cambridge University Press, 1988) is a good place to find a discussion and references for further study.

The question often arises as to why we did not use the maximum entropy or least squares instead of HI. The answer is that HI is easier to use and computationally much faster, a property which our algorithm required for use by the usual user of NMR.

The matrix pencil method is always used here to obtain frequencies and decay rates. It can also give areas directly (See equation 17 of V. Mandelshtam and H. S. Taylor, J. Chem. Phys. 107, 6756 (1997)) Alternately inserting the cleaned FID and the frequencies and decays, that is the complex frequency, into the model (See equation 6 of ref V. Mandelshtam and H. S. Taylor, J. Chem. Phys. 107, 6756 (1997); See and S. Kunifeev, H. S. Taylor, J. Phys. Chem. A 108, 743-753 (2004)) yields linear equations for the area and phases that when solved by linear least squares (See Press, W. H., Flannery, B. P., Teukolsky, S. A. Vetterling, W. T. Numerical Recipes in C. Cambridge: Cambridge University Press, 1988) gave better results; so the latter method is here used to determine the area and phases. See S. Kunifeev, H. S. Taylor, J. Phys. Chem. A 108, 743-753 (2004).

We have saved the most worrisome feature of the algorithm for the last consideration. In some of the challenging FID's where we were given the signals that were so weak or the number of transients so limited (for chemical decomposition or experimental reasons) that no gap appeared. Sometimes no elbow appeared. Here damping, changing window limits and signal length can be tried to expose one. A good elbow region is needed for the method to work; without it just accept that the method has failed.

### Running the Program (A Summary)

A single analysis is specified by the choice of two parameters. The first (M) whose default value is 2, sets any selected FID lengths at N/M, where N is the number of points in the FID. The second is the damping (LB), which defaults to the digital resolution. At this point, the analyst chooses an Ntr value which refers the analysis to the stored FID at Ntr in the Data Directory. Since this is the first FID to be examined, a window must be established. As for all Ntr , the FFT is shown and here provision is made for specifying the window. The program then produces internally a windowed FID at the Ntr and it will do so similarly whenever another choice of Ntr is made in the future. For this and for all future choices of Ntr, the program will produce automatically an SVD diagram. The operator can select an alternate logarithmic version of the diagram if it seems that it is visually more revealing. Additionally, the operator can choose to increase or decrease the ordinate spacings to get a better view of the elbow if it exists when a gap appears. The operator then chooses a value for K. Rough high side of the elbow estimates should be made for any elbow for which the gap is not clear. Once K is chosen, a cleaned signal windowed transient averaged FFT spectrum will appear. If some features, which are hopefully signal features, are apparent, manual phasing is available and should be applied as experience shows that this also leads to narrower lines in the HI spectrum. An option to use a pre-existing phase is also available. The HI spectrum is displayed when phasing of the cleaned signal is finished. Additionally, the HI should also be phased in an identical manner. Once phasing is completed the operator can choose to save an image of any window for various K+m, m=0, 1, 2 . . . spectra. Usually, m is chosen as 1, 2 and 3 but, for cases where the situation is uncertain, higher spectra for higher values of m can be also stored.

The operator now chooses the next Nₜᵣ and proceeds as before except for the windowing. If one is working interactively, the Nₜᵣ will presumably be chosen to increase. For comparison, several SVD diagrams from successive values of Nₜᵣ can be displayed and compared to see the evolution toward the gap. When a gap or near gap is observed in the elbow and K is estimated only with trepidation as say it is equal to K, an evolutionary sequence of spectra for K=K+1 and/or K=K+2, etc with sequential Nₜᵣ can be examined feature by feature. Stability, instability, bad phasing, area shrinkage, etc. are the features to look for. This can be used to support the choice of K. If it is not supportive or if an alternate choice of K is not apparent from the spectral sequences, further Nₜᵣ must be collected and analyzed. For offline operation after transient collection is completed, the last three or four FIDs in the Data Directory should be studied. The following examples demonstrate such a strategy.

### Example 1

As an example for ¹³C, a 0.040 molar solution of butyltrifluoroacetate was studied. As we wished to compare the SVDHI method to the FT method, a 24 hour run was made, collecting 3200 transients which were needed to produce the quality of FT spectrum seen in FIG. 1.1 where we estimate a S/N of about 3. The carbonyl region was chosen to be studied and a 266 point window (˜2000 to 2500 Hz) was placed around the expected frequency region. This region was chosen because carbonyl signals are challenging due to their quaternary nature. This particular example is even more challenging because of the splitting imposed by the adjacent trifluoromethyl group.

Since a 9 to 10 times saving in transients was hoped for, Nₜᵣ=320 was chosen for analysis from the NDD. After that, Nₜᵣ values in steps of Δ, which had been chosen as 40, were examined up to Nₜᵣ=560. At this point, we believed that we saw the gap opening due to the evolution seen in FIG. 1.2a-1.2g. The SVD is analogous to somewhere between FIGS. 1b and 1c. The HI spectra supported this choice of K=4. In the SVD curves, no even suggestive gap develops in the elbow region until Nₜᵣ=480. This is reinforced by the curves for Nₜᵣ=520 and Nₜᵣ=560 and this can be seen in the 8-fold expansions to the right of each curve. This suggests that K=4 is the correct value. The HI spectra were calculated using K=6 so that the expected lines would show even if there were a couple of large noise lines present. The HI spectra are shown in the second column of FIG. 1.3. The first column of FIG. 1.3 shows the traditional FFT spectra and just where only the two large center lines of the expected quartet are visible. If no foreknowledge exists, little would be learned from the FFT in this region. If one did not know that K=4 was the expected result, then at Nₜᵣ=320 one might assume that the gap has formed at K=2, but a quick glance at the K=6 HI spectrum confirms that there seems to be a quartet plus two badly phased lines. As we proceed down the second column of FIG. 1.3, you can see the instability in frequency of the two noise lines and the increase in area of the quartet lines.

This can be checked with the d values for these scans. Re-evaluation of the HI at Nₜᵣ=560 scans with K=4 shows a clear quartet with the expected 1:3:3:1 intensity pattern which is depicted in FIG. 1.4.

The final HI spectrum can now be compared to the FFT spectrum at 3200 transients (FIG. 1.1). A clear 8 to 10-fold saving in data collection time has been demonstrated.

A question: What if 360 transients were all that could be collected? Do you believe that at least you have found the splitting correctly? Your call, just as one often does in the FT method.

Estimations made without strong indications of a gap need to be treated very carefully to be believed. Consider in this example, the spectrum at 440 scans and imagine that no further transients could be collected. The gap is not very suggestive of K=4. Certainly in the spectrum feature 1 looks like a signal feature. At this point it seems to phase well and seems stable in the 360 to 480 scan range. Do not, because you were anticipating a quartet, set K=4 to get a final result as peak 1 is weightier than 2 and the latter would vanish. This would not happen at 520 where a better K=4 gap is evident. Considerations like these need to be taken in. If the gap is not big enough (as in FIG. 1c) and is only suggestive as in FIG. 1b, and if you cannot get more transients you can only say the method has failed at “Max 420”. Of course, foreknowledge of a quartets existence helps here as the spacings seem to have become fixed since 320 scans.

### Example 2

The next example is also observing ¹³C but shows that our method will work with data collected on a Bruker Instrument. The sample is a dilute solution of Kavain and the data was supplied by Joshua Hicks of Bruker Instruments. The maximum number of scans collected was 240 transients. The aromatic region between 125 and 130 ppm was analyzed with a 250 point window (˜15000 to 15600 Hz). There are 4 signals in this area located at 126.6, 126.7, 128.2 and 128.7 ppm.

FIG. 2.1 shows the sequence of 8 SVD curves with the corresponding HI spectrum. The SVD curve suggests K=4, but it is not supported. I chose K=7 as an initial value. You can see that four of the lines are frequency stable as you work down through FIGS. 2.1a-h2.

In FIG. 2.2, you can see the comparison of the basic FT and the HI spectrum with K=4.

### Example 3

The sample is a solution of 100 μl of CH₃NO₂ with natural abundance ¹⁵N in 1.0 ml CDCl₃ (7.0 μM of ¹⁵N—CH₃NO₂). The spectra were recorded in a standard Pyrex 5 mm NMR tube on a Varian 400MR spectrometer locked and without spinning.

Analysis: From the SVD curves, it becomes clear that the gap opens at K=1 after 256 or 128 transients. To double check this result, the HI spectra were calculated with K=4. In these HI spectra, all features phase independently. This implies that the spectrum can only contain one signal or simply just noise. From the four features in every trace, only the central peak remains at the same position (the X marker is constant). The central peak is the ¹⁵N signal of CH₃NO₂ at 0.0 ppm.

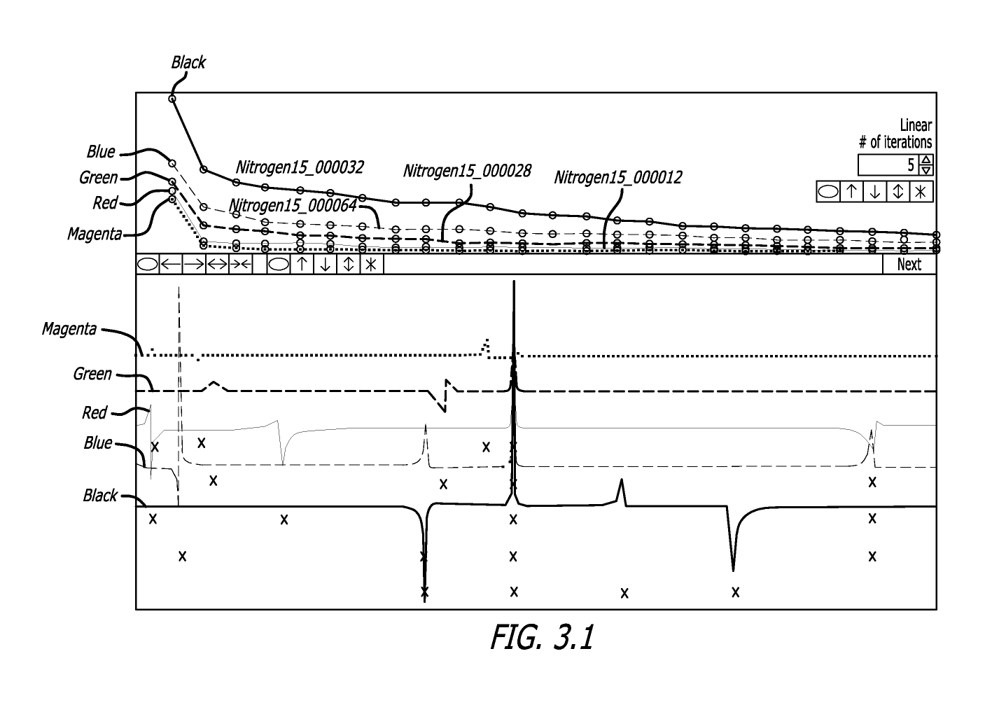

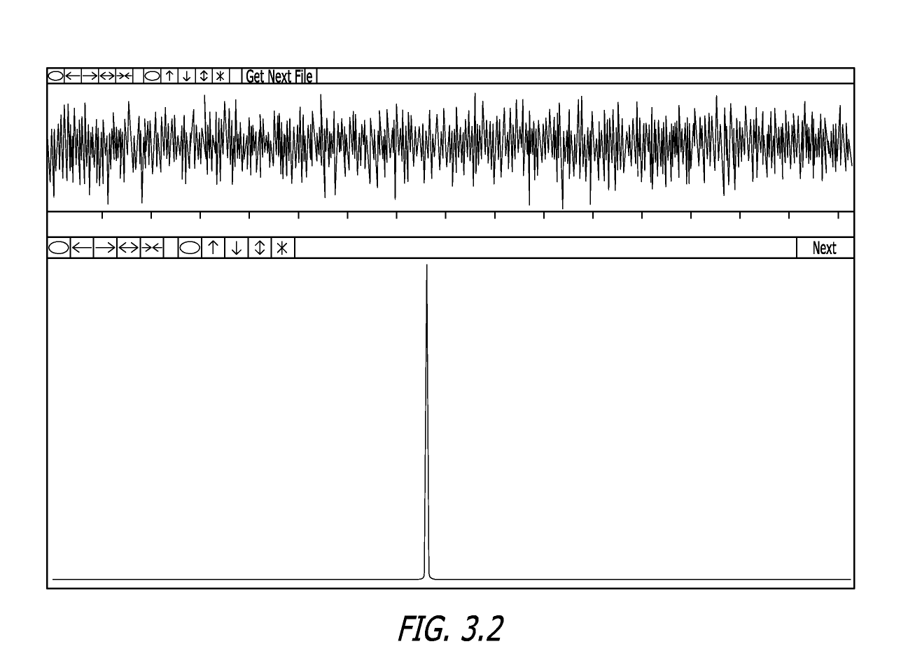

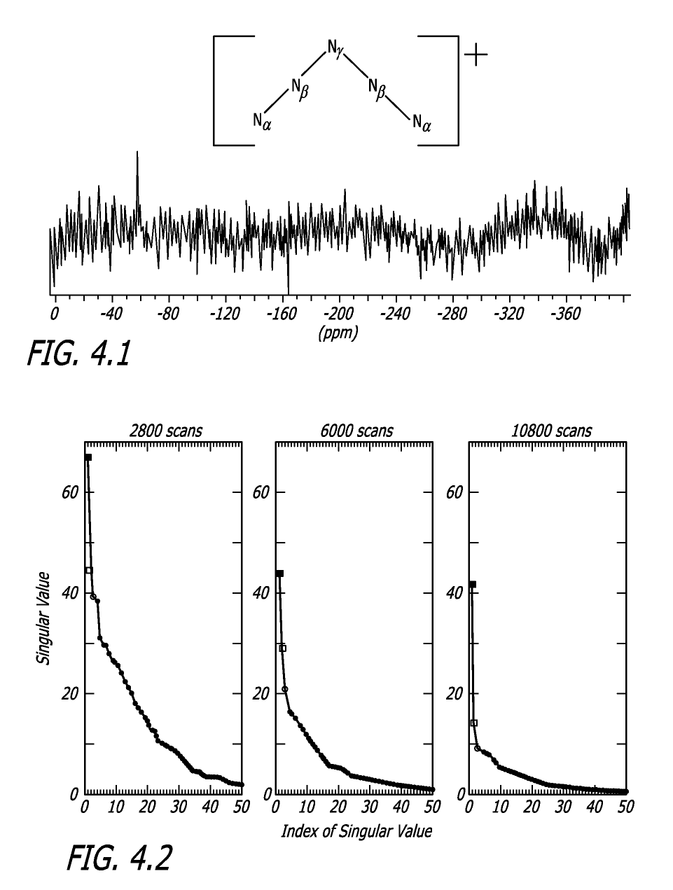

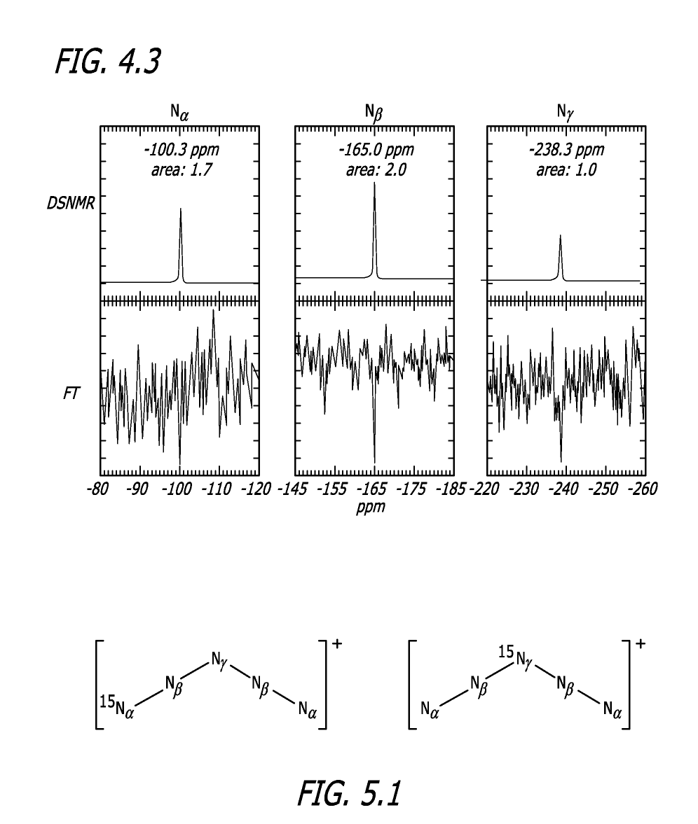

The data after 256 transients was then re-processed with K=1 after 256 transients. The obtained HI spectrum and the traditional FT spectrum are depicted in FIG. 3.2.

### Example 5

### ¹⁵N-¹⁵N Spin-Spin Couplings in N₅+. Gap, Phasing and Stability Method (2009)

This example is a borderline case in which an answer can only be obtained with the knowledge of the expected spectral features.

The sample is a solution of 196 mg N₅SbF₆-1-15N in 0.4 ml DF (1.6 M N₅SbF₆-1-¹⁵N). The spectra were recorded at 300 K on a Varian VNMRS-500 spectrometer. The sample was contained in a heat sealed 4 mm FEP inliner that was inside a standard Pyrex 5 mm NMR tube. During the recording, the sample was locked and was not spinning A total of 80,000 transients were recorded with a total acquisition time of 3.5 s per transient. The data was saved in blocks of 1,000 transients. However an additional challenge was sample decomposition and only the first 40,000 transients were found to be useable.

The N₅+ cation is V-shaped and possesses the three chemically different nitrogen atoms N_{α}, N_{β}, and N_{γ}. Therefore, the ¹⁵N NMR spectrum of N₅SbF₆ is expected to exhibit three signals. The low natural abundance of ¹⁵N (0.37%) does not allow the observation of ¹J(¹⁵N, ¹⁵N) couplings. However, the introduction of a single ¹⁵N atom per cation permits the observation of these couplings. Because of the starting material and chemistry involved in the synthesis of N₅+, the sample consisted of two different singly ¹⁵N labeled isotopomers of N₅+ (FIG. 5.1).

Half of the N₅+ cations carry the ¹⁵N label in the N_{γ} position, while in the other half, one of the two N_{α} atoms is ¹⁵N labeled.

The regions of all three nitrogen atoms, N_{α}, N_{β}, and N_{γ} have been processed with this method. In the region of the N_{α}, atom only one single line was observed at −100.3 ppm. The N_{γ} region showed the expected 1:2:3:2:1 quintet at −236.5 ppm with a ¹J(¹⁵N_{γ},¹⁴N_{β}) splitting of 17.7 Hz. Because it has no ¹⁵N enrichment, the N_{β} atom is the most challenging problem and the following discussion will focus exclusively on signals of this atom. With the knowledge that the coupling constant between N_{α} and N_{β} is too small to be resolved (singlet for N_{α}), the ¹⁵N_{β} signal at −165 ppm should be composed of two signals with very similar shift: (i) a doublet with ¹J(¹⁵N_{β},¹⁵N_{γ}) splitting and (ii) a 1:1:1 triplet with ¹J(¹⁵N_{β},¹⁴N_{γ}) splitting. From prior experience it is expected that because of an asymmetric electronic environment around the quadrupolar ¹⁴N_{γ} (I=1) nucleus, the ¹⁵N_{β}-¹⁴N_{γ} splitting collapses into one single line. Therefore, the expected spectral feature in the region of N_{β} is a doublet with an additional single line near the center of the doublet. Without this prior knowledge, it is not possible to proceed with this example and determine the absolute value of the ¹J(¹⁵N_{β},¹⁵N_{γ}) spin-spin coupling constant.

Analysis: Because of decomposition of the sample, only the first 40 k transients were usable. After some manipulation and because of prior experience, a line broadening of LB=8 Hz was used to process the data. For the SVD curves and HI spectra depicted in FIG. 5.2, a window of 275 points was chosen in the N¹₀ region. From the SVD curves, it is not clear where the gap, if any, is forming. In some curves, one might guess K=3 or K=4. To build more confidence, more transients would be necessary but this is not possible because of a decomposing sample. Keeping in mind that there should be three lines in the spectrum and with some margin of safety, K was chosen to be five. The calculated HI spectra show five features. The first feature in the spectra for 25 k to 40 k transients and last feature for 20 k transients is not stable, its position is changing and does not phase coherently. The position of the next feature is changing only slightly but, going from 20 k to 40 k transients, the ability to phase the feature is generally not observed. This behavior eliminates these features as noise. The most prominent features of the HI spectra are the next three lines that form a “quasi-triplet”. The position and relative phasing of these three lines does not change during the progression from 20 k to 40 k transients. These three lines are the strongest lines in the window. As can be seen from FIG. 3, the HI spectra calculated with K=3 show the same “quasi-triplet” of three lines (FIG. 5.3).

We can now conclude, that we see what was expected: A doublet at −164.7 ppm with a splitting of ¹J(¹⁵N_{β},¹⁵N_{γ})=25.3 Hz and an additional single line at −164.6 ppm near the center of the doublet.

It should be emphasized again that this is a borderline example because the sample decomposed during the data collection. Under normal circumstances, such data cannot be processed because the gap in the SVD diagrams is not seen clearly enough to determine the value of K with any confidence. In this specific case, the value of K could be chosen because of prior knowledge of the spectral features. The new information obtained in this experiment is the absolute value for the ¹J(¹⁵N_{β},¹⁵N_{γ}) coupling constant and the confirmation that the ¹J(¹⁵N_{α},¹⁵N_{β}) coupling constant is indeed small.

### Example 5

### Gap Method Only (2004) Small Features on BASELINE about Large Feature

31P example the E isomer of methyl α-(hydroxyimino)phosphonoacetic acid, dicyclohexylammonium (DCHA) salt (I)

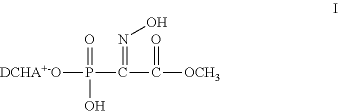

In this sample we are trying to identify the ¹³C satellites in the ³¹P spectrum.

### Example 6

### Gap Method Only (2004)

An ¹⁷O example.

### Example 7

### Solid State MAS 15N Natural Abundance

This shows that the algorithm works with solid state samples. The sample is Glycine and this is a natural abundance 15N experiment. The data was supplied by Dr. Robert Taylor of the UCLA Chemistry Department.

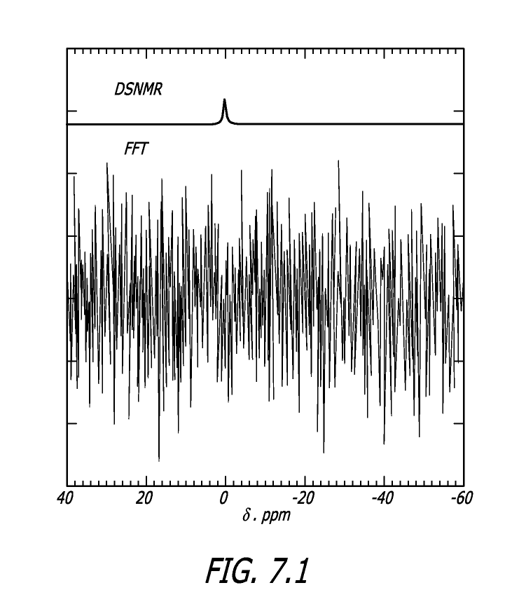

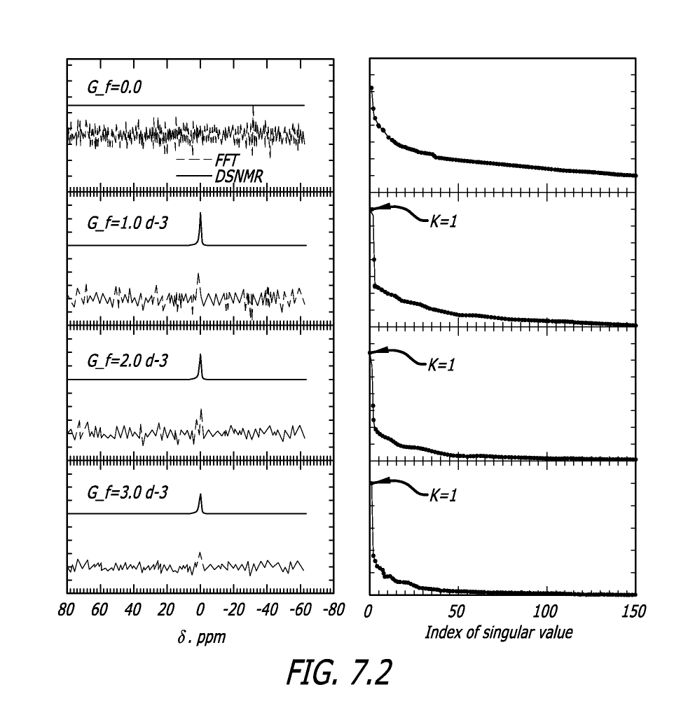

In FIG. 7.1, the SVD curve indicates that there is only one signal. I used K=3 just to be sure no other signals may have been present. As seen in the HI set, FIG. 7.2, one peak is frequency stable in all five sets. For contrast, compare this to the FT spectrum of 8 scans shown in FIG. 7.3.

### Example 8

### MAS—A Challenging 15N Natural Abundance Problem

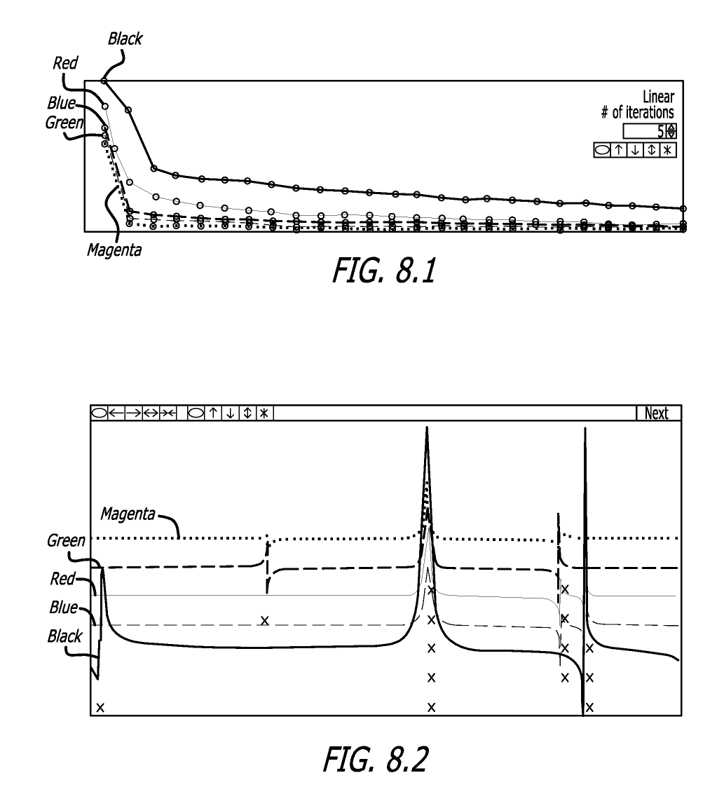

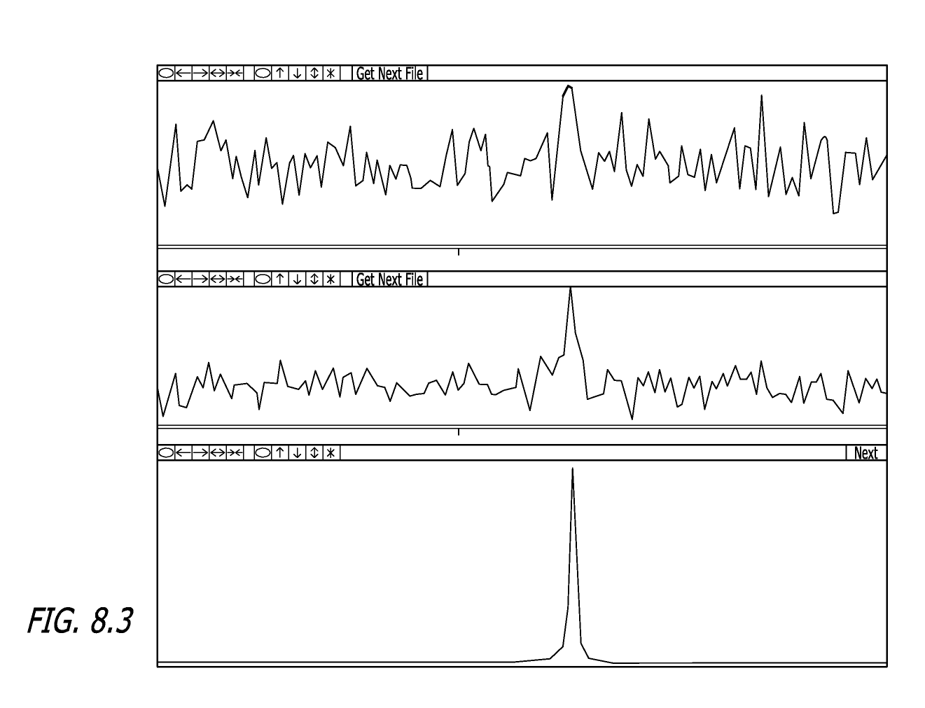

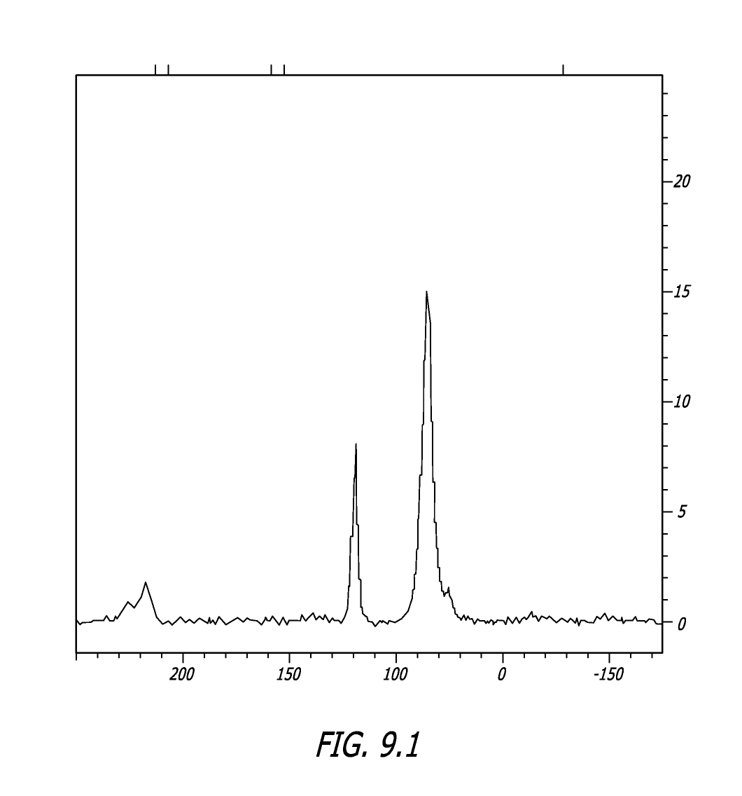

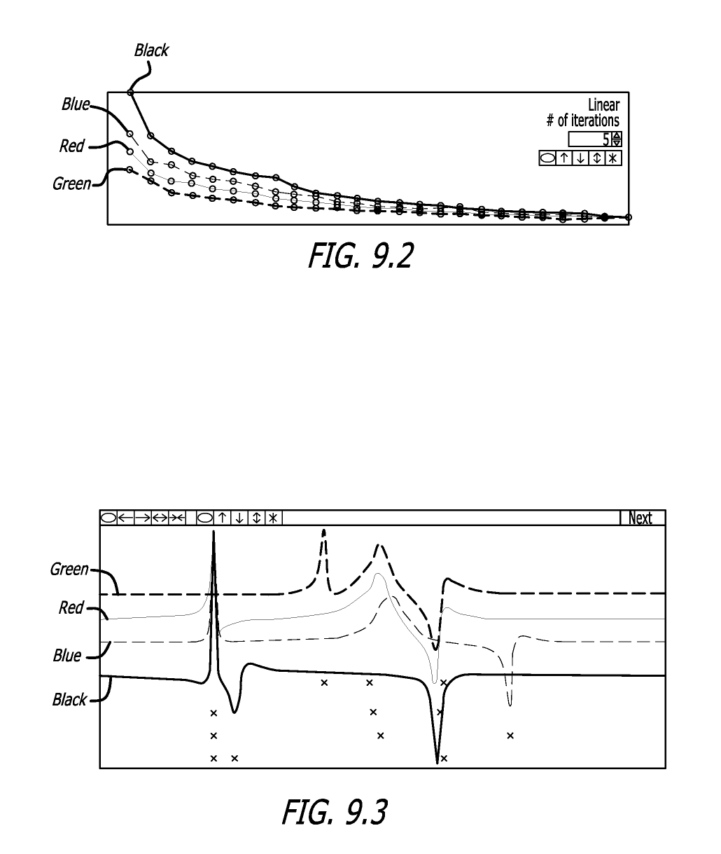

Signals supplied by Dr. Robert Taylor of the UCLA Chemistry Department. To assure that the concentration of ¹⁵N in the rotor was low, Zr-MOF—NH2 was used for the study. The linking molecule was 2-amino-1,4-carboxylic-phthallic acid. A ¹⁵N enriched sample showed, FIG. 8.1, several features but only the one at 140 ppm was deemed to be from the molecule of interest. The other signals around 70 ppm and 335 ppm derive from the enrichment process.

As the lines are broad, the natural abundance FID's, collected at 1024 scan increments, were given a 40 Hz damping. The FT showed an extremely weak signal in the last couple of sets. The SVD analysis failed to show any gap, K=3 was specified as it was deemed to be past the weak elbow as seen in FIG. 8.2.

The HI spectra for the last four available steps, which took 26 hours to obtain the nine steps total, were phased using the largest peak in the window. All features phased independently indicating that if a signal feature was present, it was a single such feature.

The broad central feature appeared as the most stable. The drift in the frequency of this peak was due to some overlap with an adjacent feature. This is shown by the fact that when K=1 was calculated, they all yielded a frequency converging towards 140 ppm.

This example is the most borderline and ‘unpublishable’ analysis done so far. No gap showed up but the above considerations ‘skewed’ for the first time a 15N feature in the natural abundance spectra that aggrees in frequency with the labeled spectra. For everyday use the unlabled result is easier to obtain and could be useful.

### CONCLUSION

It has been demonstrated that the SVDHI method has a greatly improved sensitivity over the “traditional” FFT Method. It also yields high resolution results. For low sensitivity nuclei as ¹⁷O, ¹⁵N, ¹³C etc, or for low concentrations of other nuclei and for problems where scale, that is dynamic range, is a problem, long accumulation times and/or enrichment may be avoided or reduced significantly.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

1.-7. (canceled)

8. A method for signal processing Nuclear Magnetic Resonance (NMR) spectrometer data of a sample of natural low abundance nuclei to determine one-dimensional NMR chemical shifts, the sample including a gas, liquid, or spinning solid phase sample, via a computer, the method comprising steps of:
configuring the NMR spectrometer data of the sample into a table of entries, each entry having one signal averaged Free Induction Decay (FID) output and each entry having an increasing number of transients;
computing Singular Value Decomposition (SVD) diagrams for the entries of the table;
determining whether or not, with an increasing number of transients, a cocked arm shaped SVD diagram is developed, the cocked arm shaped SVD diagram including, from left to right, an upper arm, elbow, and forearm;
selecting an indexed SVD point on the near to elbow and forearm of the cocked arm shaped SVD diagram;
based on the value of the selected indexed SVD point, only keeping SVD points of lower index to be used in computing a spectrum from each of the FIDs, computing the spectrum from each of the FIDs, the spectrum having Lorentzian features including signal and noise in number equal to the value of the selected indexed SVD point; and
based on the plurality of computed spectra in increasing number of transients, detecting and eliminating Lorentzian features corresponding to the noise.

9. The method of claim 8, wherein the step of configuring the NMR spectrometer data of the sample into the table of entries is performed in such a way that the number of transients of each entry is increased by a predetermined amount of transients.

10. The method of claim 8, wherein the step of selecting an indexed SVD point is performed by using a user input device.

11. The method of claim 8, wherein the step of detecting and eliminating Lorentzian features is performed based on the stability of reappearance of the Lorentzian features and phase coherence among the Lorentzian features.

12. The method of claim 11, further comprising the step of computing a final spectrum from the FID of the entry having the greatest number of transients in the table.

13. The method of claim 8, wherein the step of determining whether or not a cocked arm shaped SVD diagram is developed comprises displaying to a user a plurality of computed SVD diagrams in such a way that a user can determine development of a cocked arm shaped SVD diagram including an upperarm, elbow and forearm.

14. The method of claim 6, wherein the step of displaying to a user a plurality of computed SVD diagrams comprises displaying singular values of each SVD diagram in order of decreasing magnitude of singular values from the left to the right side of each SVD diagram such that the displayed singular values form a cocked arm shaped SVD diagram.

15. The method of claim 8, wherein the step of determining whether or not a cocked arm shaped SVD diagram is developed is based on at least last five SVD diagrams in order of increasing number of transients.

16. The method of claim 15, wherein the step of selecting an indexed SVD point comprises:
displaying the number of Lorentzian features from the at least last five SVD diagrams in order of increasing number of transients;
receiving an input from a user corresponding to an over-estimated number of Lorentzian features; and
based on the received input, computing a plurality of spectra from the FIDs, each spectrum having Lorentzian features in number equal to the received input.

17. The method of claim 8, further comprising the step of phasing the Lorentzian features in the SVD diagrams.

18. The method of claim 8, further comprising the steps of:
receiving information regarding at least one of an optimal signal length, damping, and spectral window size; and
applying the received information to the NMR spectrometer data of the sample for further processing.

19. An apparatus for signal processing Nuclear Magnetic Resonance (NMR) spectrometer data of a sample of low natural abundance nuclei to determine one-dimensional NMR chemical shifts, the sample including a gas, liquid, or spinning solid phase sample, the apparatus comprising:
a processor;
storage accessible by the processor;
programming to be executed by the processor; wherein execution of the programming by the processor configures the apparatus to perform signal processing functions, including functions to:
configure the NMR spectrometer data of the sample into a table of entries, each entry having one signal averaged Free Induction Decay (FID) and each entry having an increasing number of transients;
compute Singular Value Decomposition (SVD) diagrams for the entries of the table, each SVD diagram comprising a plurality of indexed SVD points;
determine whether or not a cocked arm shaped SVD diagram is developed, the cocked arm shaped SVD diagram including, from left to right, an upper arm, elbow and forearm;
receive from a user of the apparatus an input corresponding to an indexed SVD point on the cocked arm shaped SVD diagram;
based on the received input, compute from the FIDs a plurality of spectra having Lorentzian features including signal and noise in number equal to a value of the indexed SVD point; and
based on the plurality of computed spectra, determine the number of Lorentzian features corresponding to the one-dimensional NMR chemical shifts of the sample.

20. The apparatus of claim 19, wherein the number of transients of each entry in the table is increased by a predetermined amount of transients.

21. The apparatus of claim 19, wherein the execution of the programming by the processor configures the apparatus to perform a function to display to the user at least five SVD diagrams in order of increasing number of transients.

22. The apparatus of claim 19, wherein the signal processing functions to receive from a user of the apparatus an input corresponding to an indexed SVD point on the cocked arm shaped SVD diagram comprises a function to receive from the user a value corresponding to an over-estimated number of Lorentzian features.

23. The apparatus of claim 19, wherein the signal processing functions to determine the number of Lorentzian features corresponding to the one-dimensional NMR chemical shifts of the sample comprise functions to:
automatically detect and eliminate Lorentzian features corresponding to the noise; and
automatically determine the number of stable and coherently, similarly phased Lorentzian features present in the plurality of computed spectra.

24. The apparatus of claim 19, wherein the signal processing function to determine the number of Lorentzian features corresponding to the one-dimensional NMR chemical shifts of the sample comprises functions to:
display to the user at least five spectra of the plurality of computed spectra; and
receive a user input of the number of the stable and coherently, similarly phased Lorentzian features present in the displayed at least five spectra of the plurality of computed spectra.

25. The apparatus of claim 19, wherein the execution of the programming by the processor configures the apparatus to perform a function to phase the Lorentzian features in the SVD diagrams.

26. The apparatus of claim 19, wherein the execution of the programming by the processor configures the apparatus to perform functions to:
receive information regarding at least one of an optimal signal length, damping, left shifting and spectral window size; and
apply the received information to the NMR spectrometer data for further processing.

27. The apparatus of claim 19, wherein the signal processing function to determine whether or not a cocked arm shaped SVD diagram is developed further comprises functions to display to the user a plurality of SVD diagrams, wherein singular values of each SVD diagram is displayed in order of decreasing magnitude from the left to the right side of each SVD diagram such that the singular values form a cocked arm shaped SVD diagram.
